(19) United States
(12) Patent Application Publication
(10) Pub. No.: US 2003/0217038 A1
(43) Pub. Date: Nov. 20, 2003

(54) Data file history management method and apparatus thereof

(75) Inventors: Keiji Kageyama, Ami (JP); Hiromitsu Tokisue, Chiyoda (JP); Hiroyuki Nemoto, Tokyo (JP)

Correspondence Address: McDermott, Will & Emery, 600 13th Street, N.W., Washington, DC, 20005-3096, US

(73) Assignee: HITACHI, LTD.

(21) Appl. No.: 10/357,208

(22) Filed: Feb. 4, 2003

(30) Foreign Application Priority Data
May 17, 2002 (JP) 2002-143338

(51) Int. Cl. G06F 17/30

(52) U.S. Cl. 707/1

(57) ABSTRACT

In a method for managing knowledge information and data files, in relation to each other, independent upon application software, comprising the following steps of: reserving comment information and a management name into a data file; displaying each data through an icon for data file, being unique to the data file, while displaying a mutual relationship of each icon through an arrow; displaying a combined information input screen when a combining operation is executed onto two (2) or more icons, thereby prompting a user to input knowledge information for giving a meaning of changing process of a group of data files, which are designated to be a target of combination; and reserving the knowledge information as the data file, while reserving a management name indicative of an address of reservation of data of each data file and a management name indicative of an address of reservation of the knowledge information, as information for researching an icon name after combining.

### BACKGROUND OF THE INVENTION

The present invention relates to a data file history management method and an apparatus thereof, and in particular, to the data file history management method and the apparatus thereof, being suitable for managing history of a data file, which is produced in operations for editing, such as, new production, renewal, copying and/or deletion of a data file.

Conventionally, it is commonly conducted to manage the version of the data file, which is produced in the operations for editing, such as, producing a new file, renewing, copying and/or deleting, in a computer system for conducting the operations, for example, in producing and/or editing data materials and in analytic simulations. In this instance, only a result remains in the data file, but no information is reserved therein, such as, indicative of which portion of the data file was changed and on what reason, for example, in the conventional editing and renewal operations of the materials. For reserving the information relating to the knowledge of a human being as such, it is necessary to reserve the knowledge information in a form of other data file after making a relationship correctly between the data file and the knowledge information. In such the case, various ways or methods are adopted, i.e., to be reserved in what kind of formats and/or which kind of files, for example, depending on a person and an organization. Ordinarily, a rule is made up in the organization, and it is often practiced that the information is inputted and/or reserved in accordance with such the rule.

On the contrary, a technology is proposed, for enabling to have the contents of changing with ease, by remaining the history of renewal. As is described in Japanese Patent Laying-Open No. Hei 5-128179 (JP-A 128179 (1993)), for example, also a changing history of CAD data is managed when managing the history of data file on a computer, thereby making the management of the data file easy, which was conventionally relied upon a memory of a designer who uses the CAD system. With this technology, it is possible to make a record of the contents of changing, such as, change in shape and/or change of position of a diagrammatical element(s) in the two (2) CAD data, for example.

Also as is described in Japanese Patent Laying-Open No. 2000-235561 (JP-A 235561 (2000)), there is proposed a simulation model editing apparatus comprises a renewal history list storing portion, a model storing portion and a command database, wherein the editing content is recorded with the version information, in a time sequence, for each of the simulation models, and thereafter the editing content is searched out and/or displayed, thereby knowing the manner or way; how the simulation model is changed into, easily.

In general, various kinds of application software are used depending on the data file as a target, in the edition and/renewal of materials by using a computer system. In particular, it is not easy to add a history management process for storing the changing history into the application software, which is available on the market, therefore such the application software, into which the history management process can be added, must be a software which is independently developed. For this reason, the conventional technology has also such the structure, that comprises a means for extracting/recording the renewal history in an editing means when recording/managing the renewal history. Since there are plural numbers of data in kinds, and the applications, in the editing operation of materials by using the computer system, therefore a means is necessary, being independent upon the application software, for the purpose of managing the changing history of the data file, in the form of not relaying on the data and the application software.

Also, there may be a case that the inputting and reserving are not necessarily completed, in the method where inputting/reserving is made by a user in accordance with the rule made in advance when reserving the knowledge information in relation to the data file thereof. In particular, the operation of inputting/reserving is often omitted when the user feels to “be busy now”, and then the important knowledge information is owned only by the user, so that the knowledge information cannot be easily referred by other users.

### BRIEF SUMMARY OF THE INVENTION

An object is, according to the present invention, to provide a data file history management method, being able to manage knowledge information and a data file in relation to each other, but independent upon application software, and an apparatus thereof.

For accomplishing the object mentioned above, according to the present invention, there is provided a method for managing data file history, comprising the following steps of: reserving a data file produced accompanying an input of data upon basis of edition operation, with comment information, to be history information, relating to a management name thereof; displaying plural numbers of data files on a display screen, through an icon for data file unique to each of the data files, responding to the editing operation of the data files, and also displaying a relationship of the each of the icons through an icon for showing history; displaying a combined information input screen on said display screen when a combining operation is executed on at least two or more of the plural numbers of icons for data files displayed on said display screen; reserving knowledge information as the data file, when said knowledge information is inputted for giving meaning onto changing processes of a group of the data files, which are designated to be a target for said combination, accompanying the display of said combined information input screen; and reserving a management name indicative of an address of reservation of the each data of the group of data files, which are designated to be said target of combination, and a management name indicative of an address of reservation of said knowledge information, to be information for searching an icon name after combining.

In applying the method for managing data file history, as described in the above, according to the present invention, it is possible to add the following elements thereto:

(1) The respective comment information of the group of data files, which are designated to be said target of combining, is displayed in a designated area on said combined information input screen, together with the management name of the each data file designated to be said target of combining, when displaying the combined information input screen on said display screen.

(2) Displaying a group of data files designated to be a target of said combination on said display screen by an icon for a combined data file, being unique to said group of data files, when the editing operation is executed on the data files including the group of data files, which are designated to be said target of combination, responding to that editing operation; displaying other uncombined data files, which are designated in said editing operation, on said display screen by the icon for data file, being unique to said other uncombined data files; and displaying a mutual relationship of said each icon on said display screen by an icon for history.

(3) If an extension operation is executed on the icon for the combined data file, when the icon for combined data file of the group of data files, which are designated to be said target of combination, is displayed on said display screen, the group of data files before combination are searched, belonging to said icon for the combined data file by using the management name as the search information, and a group of data files obtained in this search and other data files relating before the combination are displayed on the display screen by icons for data file, each being unique to said data file, while displaying the mutual relationship of said each icon on said display screen by the icon for history and restoring the icon before the combination on said display screen.

(4) If a display operation is executed on the icon for the combined data file, when the icon for combined data file of the group of data files, which are designated to be said target of combination, is displayed on said display screen, search is made on said knowledge information while searching on the group of data file before the combination, belonging to said icon for combined data file, by using the file name after combination as the search information, and a combined information input screen is displayed on said display screen, while displaying the management name, comment information and the knowledge information of each the group of data files before said combination, in an area designated in said combined information input screen respectively.

(5) A base management name indicative of the management name of a producer of said history information is reserved when said data and comment information are reserved as the history information by relating to the management name, and when icons for data files are displayed in plural numbers thereof on said display screen, while deleting the icon for data file designated in said deletion operation, an icon for history is displayed, being indicative of a mutual relationship between icons for data files having a relation to said icon for data file, which is deleted, among remaining icons for data files, while reserving comment information of the data file for deletion corresponding to the icon for data file, which is designated in said deleting operation, into a data file at an address of reservation, which has a management name of said data file for deletion as a base management name thereof, and changing the base management name of said data file at an address of reservation into the base management name reserved in said data file for deletion and reserving, and thereafter said data file for deletion is deleted, if deletion operation is executed on any one of said icons for data files.

(6) In advance to reservation of each of said data files, a reserve condition is set up for the data file to be reserved in a process where said each data file is produced, and only the data file is reserved, being in conformity with said reserve condition set up, when said each data file is produced.

(7) A plug-in menu for designating the reserve condition of said data file is displayed on an application display screen.

(8) A search is executed on said history information and the knowledge information and the file name as a search target, upon basis of said key word, when a key word search operation is executed accompanying an input of a key word, and a data file is displayed on the display screen by means of an icon for data file, if it is extracted to include said key word therein in that search.

Also, according to the present invention, there is provided an apparatus for managing data file history, comprising: a history information reserving means for reserving a data file produced accompanying an input of data upon basis of edition operation, with comment information, to be history information, relating to a management name thereof; an icon displaying means for displaying plural numbers of data files on a display screen, through an icon for data file unique to each of the data files, responding to the editing operation of the data files, and also displaying a relationship of the each of the icons through an icon for showing history; a combined information input screen displaying means for displaying a combined information input screen on said display screen when a combining operation is executed on at least two or more of the plural numbers of icons for data files displayed on said display screen; a knowledge information reserving means for reserving knowledge information as the data file, when said knowledge information is inputted for giving meaning onto changing processes of a group of the data files, which are designated to be a target for said combination, accompanying the display of said combined information input screen; and a combined file reserving means for reserving a management name indicative of an address of reservation of the each data of the group of data files, which are designated to be said target of combination, and a management name indicative of an address of reservation of said knowledge information, to be information for searching an icon name after combining.

When building up the structure of the apparatus for managing data file history, as described in the above, also according to the present invention, the following element can also be added thereto.

Said history information reserving means reserves a base management name indicative of an management name of a producer of said history information, when reserving said comment information to be the history information with relating to the management name.

With such the means mentioned above, an icon for data file unique to each data file and a mutual relationship of each icon are displayed on the display screen when the information relating to the data file responding to the editing operation of the data file, the combined information input screen is displayed on the display screen when the combining operation is executed on two (2) or more icons, thereby prompting an input of the knowledge information for giving a meaning onto the changing process of the group of data files, which are designated to be the target of combination, and the management names, each being indicative of an address of reservation for each of the data of the group of data files, which are designated to be the target of combination, while reserving the inputted knowledge information as the data file, when the knowledge information is inputted, therefore it is possible to relate the knowledge information and the data file with each other independent on the application software. And, when displaying the combined information input screen, each comment information for the group of data files, which are designated to be the target of combination, is displayed together with the management names, in an area designated within the combined information input screen, thereby enabling the user to refer to the comment information when she/he inputs the knowledge information.

On a while, after inputting the knowledge information relating to the group of data files, which are designated to be the target of combination, the group of data files designated to be the target of combination are displayed on the display screen through an icon for the combined data file, being unique to the group of data files, while displaying other uncombined data files on the display screen through an icon, being unique to the uncombined data files, and further the mutual relationship of each icon is displayed on the display screen through an icon for history, thereby enabling to have the relationship between the combined data file and the uncombined data file easily.

Also, if an extension operation is executed on those icons when the icons for the combined data file are displayed on the display screen, a search is made on the group of data files before combining, which belong to the icon for the combined data files, by using the management name as the search information, and the data files relating to each other before combining are displayed on the display screen through the icons for data file, while the mutual relationship of each icon is displayed through the icon for history, thereby enabling restoration of the icon before combining on the display screen.

Also, if a display operation is executed on the icon for the combined data files when it is displayed on the display screen, a search is made on a group of the combined files belonging to the icon for the combined data file and the knowledge information, using the management name after combining as the search information, and each of the management names of the group of data files before combining and the comment information and the knowledge information can be displayed in an area designated in the combined information input screen while the combined information input screen is displayed on the display screen, therefore it is possible to have the contents of the knowledge information for giving a meaning onto the changing process of the group of data files, which are designated to be the target of combination.

When the data file is reserved, the management name relating to the file name thereof is also reserved, while the base management name indicative of the management name of a producer of the history information, and when plural numbers of icons are displayed on the display screen, if deleting operation is executed on any of those icons, the icon designated in the deleting operation is deleted while displaying the mutual relationships between the icons, which have relations with the icon to be deleted through the icons for history, and the base management name of the data file at the address of reservation is changed into the base management name, which was reserved in the data file for deletion, to be reserved, while reserving the comment information of the data file for deletion, corresponding to the icon to be deleted, into the data file at the address of reservation, and thereafter the data file for deletion is deleted, therefore it is possible to remain the necessary comment information among the mutual relations of the remaining data files and the information included in the data files deleted, even when the data file is deleted.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing an embodiment of a data file history management apparatus, according to the present invention;

FIG. 2 shows an example of a display screen in a data file history management method, according to the present invention;

FIG. 3 is a view for explaining a selecting condition of plural numbers of files in the data file history management method, according to the present invention;

FIG. 4 shows an example of an input screen of combined information in the data file history management method, according to the present invention;

FIG. 5 is a view for showing examples of icons displayed, including a knowledge icon in the data file history management method, according to the present invention;

FIG. 6 is a view for explaining the structure of a combined file database in the data file history management method, according to the present invention;

FIG. 7 is a view for explaining the method for selecting unnecessary file in the data file history management method, according to the present invention;

FIG. 8 shows an example of the display after deletion of the unnecessary file in the data file history management method, according to the present invention;

FIG. 9 is a view for explaining the structure of a history information database when deleting the unnecessary file in the data file history management method, according to the present invention;

FIG. 10 is a view for explaining the method for reserving the history file in the data file history management method, according to the present invention;

FIG. 11 is a view for explaining the relationship between a reserve menu and the timing thereof in the data file history management method, according to the present invention;

FIG. 12 is a view for explaining the reservation method for a group icon in the data file history management method, according to the present invention;

FIG. 13 is a view for explaining the operation method of a plug-in menu installed in the application in the data file history management method, according to the present invention; and

FIG. 14 is a view for showing an example of a screen for use of search in the data file history management method, according to the present invention.

### DETAILED DESCRIPTION OF THE INVENTION

Hereinafter, embodiments according to the present invention will be fully explained by referring to the attached drawings.

<Embodiment 1>

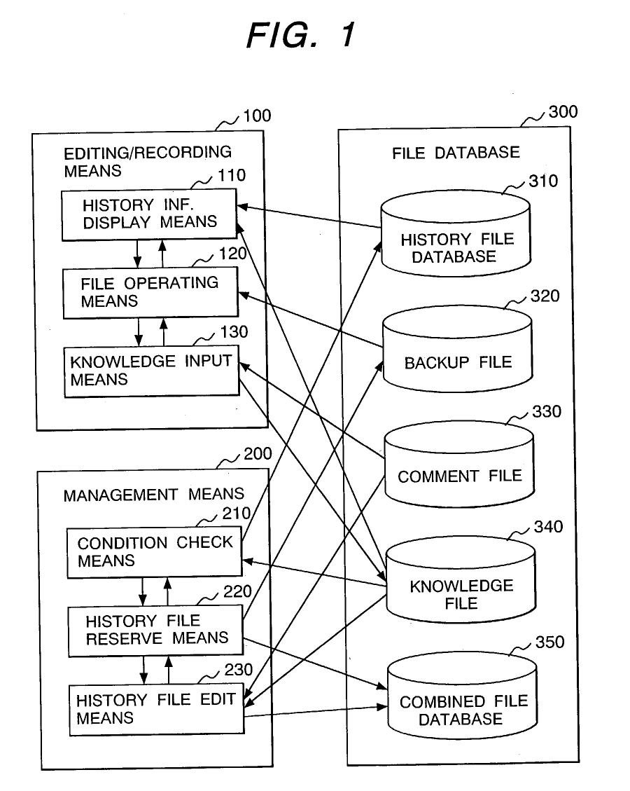

FIG. 1 is the block diagram for showing an embodiment of a data file history management apparatus, according to the present invention. The data file history management apparatus includes a display screen for showing various kinds of pictures and icons thereon, such as a CRT, etc., for example, and a program for displaying various kinds of pictures on the display screen, and it comprises: an editing/recording means 100 for a user to conduct an operation of displaying/editing of files and so on, a management means 200 for managing history information of data files, being constructed by a CPU or the like, for example, as a main element thereof, and a file database 300 for storing the data in relation to the data file in a form of backup data, as well as, the history information in relation to that data file, being constructed with a hard disc or the like, for example, as a main element thereof.

The editing/recording means 100 further comprises a history information display means 110 for displaying the data files by means of or through an icon for data file, which is inherent or unique to that data file, in response to an editing operation, as well as, for displaying a relationship of data files defined therebetween, for each, on the display by means of an icon for history, a file operation means 120 for displaying a screen for selecting the data file on the screen, as well as, for conducting a start or initialization of application software and an editing operation of the icon, etc., and a knowledge (knowledge information) input means 130 for displaying a combined information input screen and/or a comment information input screen on the display screen, as well as for requiring a user to input a comment information and/or knowledge information, so as to give an instruction for reserving the comment information and/or the knowledge information inputted.

The management means 200 comprises a condition checking means 210 for checking on presence of the data file and on a renewal date, a history file reservation instruction means 220 for detecting the renewal of data file through the checking in the condition checking means 210, and for giving an instruction for reservation of the data under the renewal condition, and a history file editing means 230 for operating the data in the file database 300, and for conducting edition of combining the reserved data files into one group, in accordance with the reservation instruction from the history file reservation instruction means 220, or deleting a data file unnecessary, for example.

The file database 300 comprises a history information database 310 for storing (reserving) therein the history information collected through the condition check means 210, a backup file 320 for storing (reserving) therein the data file, being instructed by the history file reservation instruction means 220, a comment file 330 for reserving therein a comment (comment information) inputted through the knowledge input means 130, a knowledge file 340 for reserving therein the knowledge information inputted through the knowledge input portion 130, and a data file database 350 for reserving therein the data file in a form of a set when the plural numbers of data files are combined into one group, in accordance with the instruction from the file operation means 120 and the history file editing means 230.

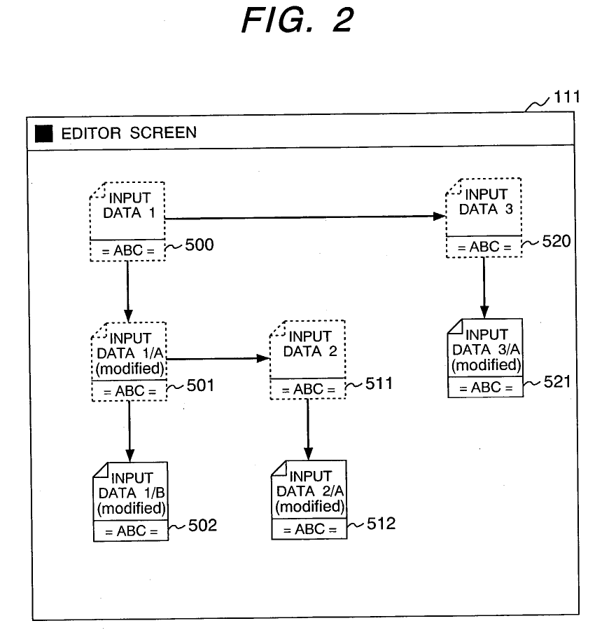

With such the structure mentioned above, the data file, which is produced accompanying with inputting of data upon the editing operation, is reserved into the file database 300 as the history information, together with the comment data thereof, in relation to a management name (a name or title relation to the file name), in the process of conducting the editing works (editing operations), such as, newly producing, renewal, copying and deletion of the data file, for example. And when the editing operation is conducted for displaying the data file icon, the plural numbers of data files are displayed on the display screen, in particular an editor screen 111 on the CRT, as shown in FIG. 2, through the respective icons 500, 501, 502, 511, 512, 520 and 521 for data files, each being unique or inherent to the data file. At the same time, the relationship of each icon is displayed on the screen, through an icon for history, such as an arrow, for example. In this case, the arrow directing downward indicates the renewal, while that directing to the right (the horizontal direction) the copying.

For example, the data file, which is indicated by the icon 501 and has the management name “input data 1/A” on the history file thereof, indicates the condition that it is renewed from the data file indicated by the icon 500 (the file name “input data 1”), and the data file indicated by the icon 502 (the management name “input data 1/B”) the condition that it is renewed from the data file (the management name “input data 1/A”). In this instance, the data file remaining at the end by the file name “input data 1” is the data file (of the management name “input data 1/B”) indicated by the icon 502, and the icon relating to this data file is indicated by a solid line.

Herein, “input data 1/B” is the management name of the history file, according to the present embodiment, and the management name in relation to the file name “input data 1” is renewed from “input data 1” into “input data 1/A”, and then into “input data 1/B”. And, the data relating to the data files of the icons 500 and 501, which are indicated by a dotted line, are not on a computer (i.e., a CPU), however they are reserved into the backup file 320 as the backup data, together with the data relating to the data file corresponding to the icon 502, upon the basis of an instruction of the history file reservation instruction portion 220.

Also, the data file of the file name “input data 2”, which is indicated by the icon 511, is the file that is produced by copying the data file of the management name “input data 1/A”, and this data file is further renewed into the data file of the management name “input data 2/A”, as shown by the icon 512. In the similar manner, the data file of the file name “input data 3”, which is indicated by the icon 520, is the file taht is produced by copying the data file of the management name “input data 1”. The data file of the management name “input data 3/A” is produced through renewal of the data file of the file name “input data 3”.

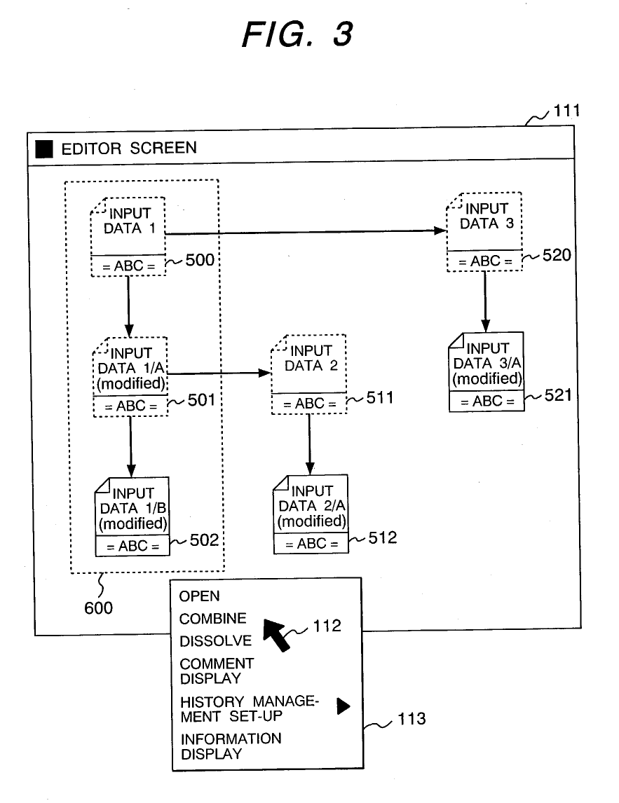

Next, explanation will be made on an operating method when the plural numbers of renewed data files are combined into one group, by referring to FIG. 3. In this instance, an icon is selected as a target of combining, by using a pointing device; such as, a mouse, for example, as one of the input devices of the computer. For example, when the icons 500, 501 and 502 are combined into one group, those icons 500, 501 and 502 are selected through the dragging operation of the mouse. Since a square area indicates this area of selection, depending on the movement of the mouse, it is enough for the user to operate the mouse, so that all of the icons 500 to 502 are within this area. After the selecting operation by means of the mouse, a popup menu 113 for selection of plural icons appears on the display screen when a button is pushed down on the mouse. In this popup menu 113, there are displayed “Open”, “Combine”, “Dissolve”, “Comment Display”, “Set History Management”, and “Information Display”. Namely, commands are displayed on this popup menu 113, in a form of the menu, being available when selecting the plural numbers of ions. In this instance, a mouse cursor 112 is shifted to the command “Combine” for grouping on the popup menu 113, thereby initiating the combining operation for the purpose of selecting the command.

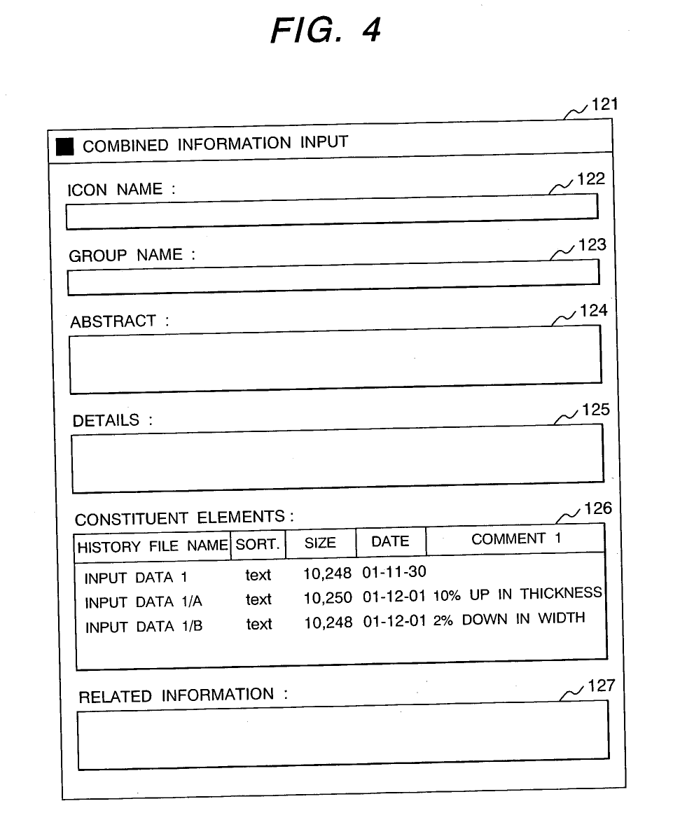

When conducting the “Combine” command selection operation, a combined information input screen 121 is displayed on display screen of the CRT, as shown in FIG. 4. On this combined information input screen 121, there are displayed input fields 122, 123, 124 and 125 for inputting an “icon name”, a “group name”, a “abstract” of knowledge of grouping (i.e., the knowledge information), and “details”, which are set for the grouped icon, in the areas designated respectively, for the purpose of representing the plural numbers of selected icons by one grouping icon.

In the input field 122, a name is inputted, such as “knowledge 1”, for the icon, when the icons 500, 501 and 502 are combined into one group, through operation by the user. Also, a group name for the grouped icons is inputted into the field 123, through operation by the user. Further, information is inputted into the field 124, such as a reason of change, an effect after change, etc., for example, as the knowledge information to give a meaning on the process of change when changing the data files corresponding to the icons 500, 501 and 502, through operation by the user. Moreover, detailed information is inputted into the field 125, as the details of the knowledge information among the information to be remained in the process of changing the respective data files. Then, the information inputted into the fields 124 and 125 are reserved into the knowledge file 340 as the knowledge information, i.e., the knowledge. It is possible to find out the knowledge information stored in the knowledge file 340, for example, as the information to be searched by the icon name after combination. Thus, the knowledge information is reserved into the knowledge file 340 with the icon name to be the information for search.

Also, a file name and/or a management name relating to each of the data files, which are designated to be the targets of combination, as well as, the information relating to the comment information thereof, are displayed in the field 126, as the information relating to the constituent elements. For this reason, the user can refer the information displayed in the field 126 when inputting the information into the fields 122 to 125.

Also, other information is inputted into the field 127, through operation by the user, such as, the information relating to a reference name and the materials, for example, as the related information thereof. This information is also reserved into the knowledge file 340, in the similar manner as the knowledge information. And, the “Combine” command is executed when the information is inputted into each of the fields on the combined information input screen 121.

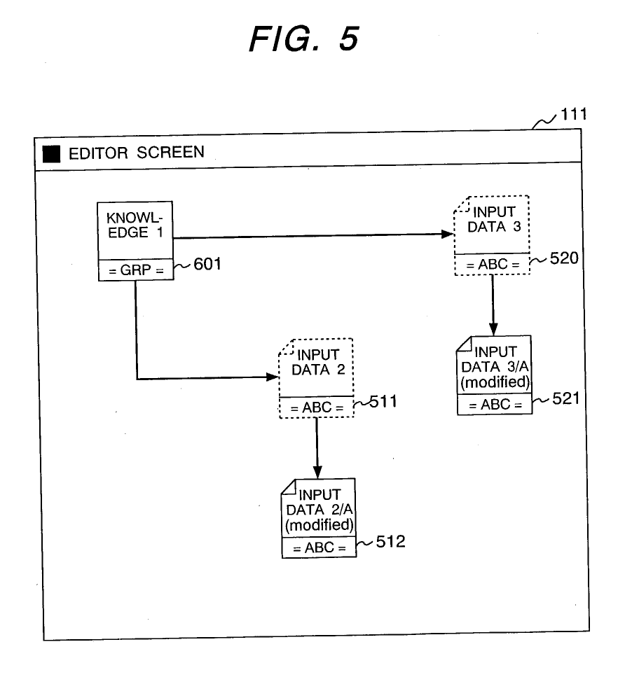

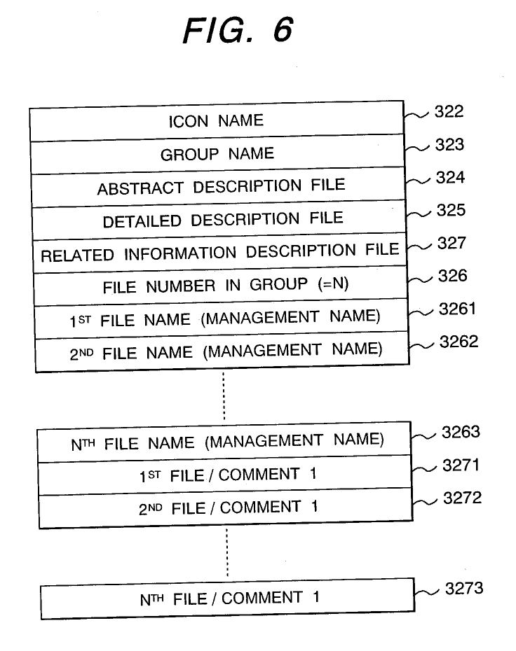

When executing the “Combine” command, a knowledge icon 601 is displayed on an editor screen 111 of the CRT, together with the icons 511, 512, 520 and 521, which are grouped, as shown in FIG. 5. Also in this instance, there are displayed the relationship between the knowledge icon 601 and the icon 511, as well as that between the knowledge icon 601 and the icon 520, by arrows to be the icon for history. Namely, it is indicated that the data file indicated by the icon 511 is produced through copying of the data file relating to the knowledge icon 601, and that the data file indicated by the icon 520 is produced through copying of the knowledge icon 601.

When conducting the operations, i.e., selecting the knowledge icon 601 when the knowledge icon 601 is displayed, for displaying the popup menu including “Extend”, and selecting the “Extend” command when the popup menu including it is displayed, then search is conducted in relation to the file database 300, by making the icon name (the knowledge 1) after combining thereof as the information for searching, and as shown in FIG. 2, it is possible to restore the icon before combining to be displayed.

Also, such the combined information input screen 121 is displayed, as shown in FIG. 4, on the screen of the CRT, if “Content Display” command is selected when the popup menu including the “Content Display” is displayed, and the information relating to the knowledge icon 601 is displayed, therefore the user is able to have the contents of the knowledge icon 601.

On a while, only a list of the data files relating to the knowledge 1 is reserved into the combined file database 350, when reserving the information, relating to a group of data files included in the knowledge icon 601, into the file database 300.

In more details, the followings are reserved in the combined file data base 350: i.e., an icon name 322, a group name 323, a summary description file 324, a detail description file 325, a reference information description file 327, an in-group file number 326, as the elements thereof; a first (^{st}) file name (the management name) 3261, a second (2^{nd}) file name (the management name) 3262, . . . a N^{th} file number (the management name) 3263, as the respective file names or the managing names; and a first (1^{st}) file comment 3271, a second (2^{nd}) file comment 3272, . . . a N^{th} file comment 3273, as the comment information registered in the each file. For example, the knowledge 1 is set into the icon name 322, the group name of the filed 123 into the group name 323 as it is, the file name of the field 124 into the summary description file 324, the file name of the field 125 into the detailed description file 325, and the file name of the field 127 into the related information description file 327 as it is. Into the first (1^{st}) file name 3261, for example, the file name or the management name of the icon 500 is set, and into the second (2^{nd}) file name, the management name of the icon 501, for example. Also, the comment information is set into the first (1^{st}) file comment 3271, relating to the data file of the input data 1 corresponding to the icon 500, and the comment into the second (2^{nd}) file comment 3272, relating to the data file of the input data 1/A corresponding to the icon 501.

Namely, the file names, etc., are set and reserved into the combined file database 350, relating to each of the data files, and the data are reserved into the backup file 320 and/or the comment file 330 or the knowledge file 340.

A reason, why the data are not directly reserved into the combined file database 350, such as, the summary and the details etc., is for the purpose of making the data management easy, by managing all the constituent elements, like a container of character trains in the same size. There is possibility that the data relating to the summary and/or the details is a long document, and the size of the container of elements may be variable, and if so, there is necessity to make management thereon. Therefore, by making the size of the container as constant, it is possible to escape from such the management on the size of the container.

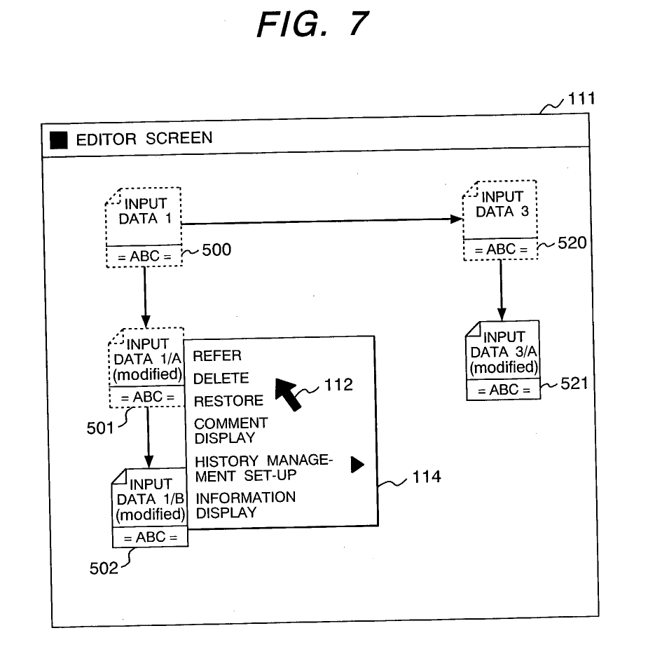

Next, explanation will be given on a method for deleting the history file (the data file) unnecessary, by referring to FIGS. 7 to 9.

There sometimes occur cases where a data file of no meaning is produced in the process of changing the data file, such as, upon periodical reservation through the automatic reservation function of the application being used, and a contemporary reservation conducted contemporarily for the convenience of an operator, in particular, in the process of renewing the data file. In such the case, deletion is conducted on the history file after confirming that the reservation of it has no meaning for the history file of the version, thereby to reduce the data capacity.

For example, the icon 501 is selected to be deleted with using the mouse when the icons 500, 501, 502 and 520 are displayed on the editor screen 111 of the CRT, as shown in FIG. 7, and then a button of the mouse is pushed down, thereby displaying a popup menu 114 for a time when selecting an imaginary (or ghost) file. In the popup menu 114 are included “Refer”, “Delete”, “Restore”, “Comment Display”, “History Management Set-up”, and “Information Display”.

Herein, “imaginary (or ghost) file” is such a contemporary one, that is produced in the changing process of the data file, and it means to be an icon only for the purpose of displaying a data file having no substance, but except for the data file for backup use, which are reserved in the backup file 320, therefore it is displayed by a dotted line. On the contrary to this, a final version of changing, i.e., the icon 502 corresponding to the management name “input data 1/B”, is the data file having the substance on the computer, and that icon corresponding to this data file is called by “actual file icon”, therefore it is displayed by a solid line.

In the case of FIG. 7, the icons 500, 501 and 520 are indicated to be the “imaginary (or ghost) files”, while the icons 502 and 521 the “actual file icons”. However, the data relating to each icon is reserved in the backup file 320 in the form of backup data, and it can be referred and/or restored on the contents of each data file thereof, by searching through the backup file 320. At the same time, it is also possible to refer to the backup file 320, the comment recorded and the information relating to the file.

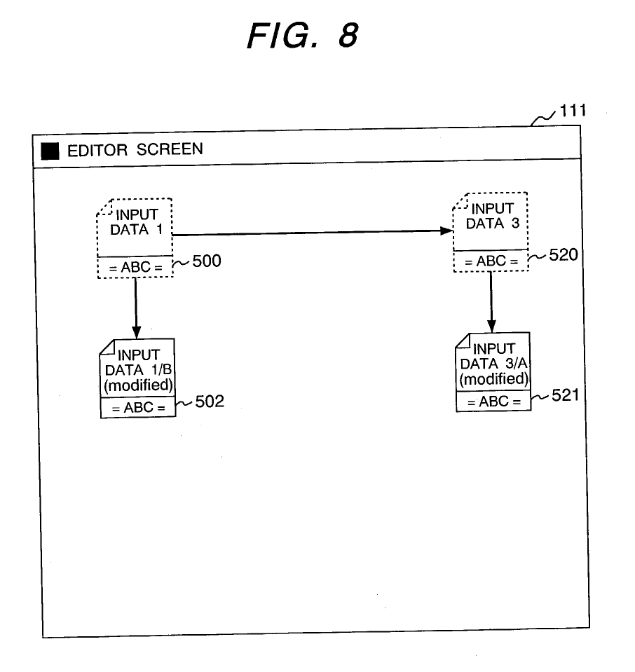

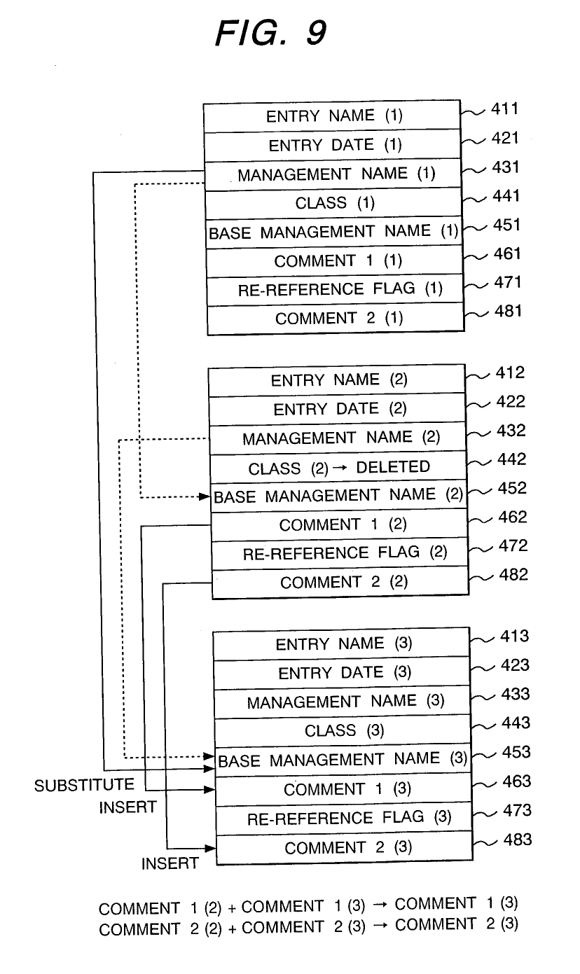

If conducting the operation for selecting the “Delete” command when the popup menu 114 is displayed, the icon 501 is deleted on the screen, as shown in FIG. 8. The icons 500 and 502 are displayed to be remained ones, and at the same time they are related to each other by means of an arrow. Namely, the data file relating to the icon 502 is so displayed that it is renewed from the data file of the icon 500. In this case, information for relating the data files to each other is reserved into the history information database 310, when the data relating to each data file is reserved, for the purpose of protecting the necessary information from being deleted within those relating to the icon 501, as shown in FIG. 9.

For example, the following data are reserved in a memory area for memorizing each data file: entry names 411, 412 and 413; entry dates 421, 422 and 423; management names 431, 432 and 433; classes 441, 442 and 443; base management names 451, 452 and 453; first (1^{st}) comments 461, 462 and 463; re-reference flags 471, 472 and 473; and second (2^{nd}) comments 481, 482 and 483.

Herein, “input data 1” is described in the management name 431, when the data of the data file relating to the icons 500, 501 and 502, and “input data 1/A” are described in the management name 432, and “input data 1/B” in the management name 433. And, the management name of a producer of the history information is described in the base management name 452, as the management name indicative of an origin of renewal name; for example, the management name “input data 1” of the management name 431 is described as it is, and the management name “input data 1/A” of the management name 432 in the base management name 453 as it is.

Herein, when conducting the operation for deleting the icon 501, the management name “input data 1” of the management name 431, which is the producer thereof, is described in the base management name 453, in advance to deletion of the data file relating to the icon 501. With this, it is defined that the data file relating to the icon 502 is produced through renewal of the data file of the icon 500. At the same time, the comment information of the first (1^{st}) comment 462 is added into a (1^{st}) comment 463, thereby being produced to be a new first (1^{st}) comment 463. Further, the comment information described in the second (2^{nd}) comment 482 is added into a second (2^{nd}) comment 483, thereby being produced to be a new second (2^{nd}) comment.

With conducting such the processing mentioned above, it is possible also to reserve the comment information described in the icon 501 to be deleted, and to delete only the icon 501 as to be the unnecessary substance. And after completing the renewal processing mentioned above, the data files relating to the icon 501 are deleted, which are reserved in the backup file 320.

In this manner, according to the embodiment 1, since each the data file is divided into one before renewal and one after renewal, and each file is related to by means of the base management name, therefore deletion can be conducted on the relationship between the data files each other, in accordance with the base management name, after executing the operation of deletion, even when deleting the data file.

Also, according to the embodiment 1, it is possible to reserve/manage the data, the reason for change of contents, and/or a condition in changing process, corresponding to the knowledge information, which are not reserved in the data file, in conformity with the history of renewal of the data file, in the operation with using a computer system, such as, the producing/editing operations for materials, and/or the analytic simulation through the computer, etc.

Further, though the knowledge information is not necessarily inputted by the user, however if using the present system, it is possible to absorb the knowledge information to be reserved, with certainty, through displaying the screen for inputting the knowledge information during operation of the data file.

<Embodiment 2>

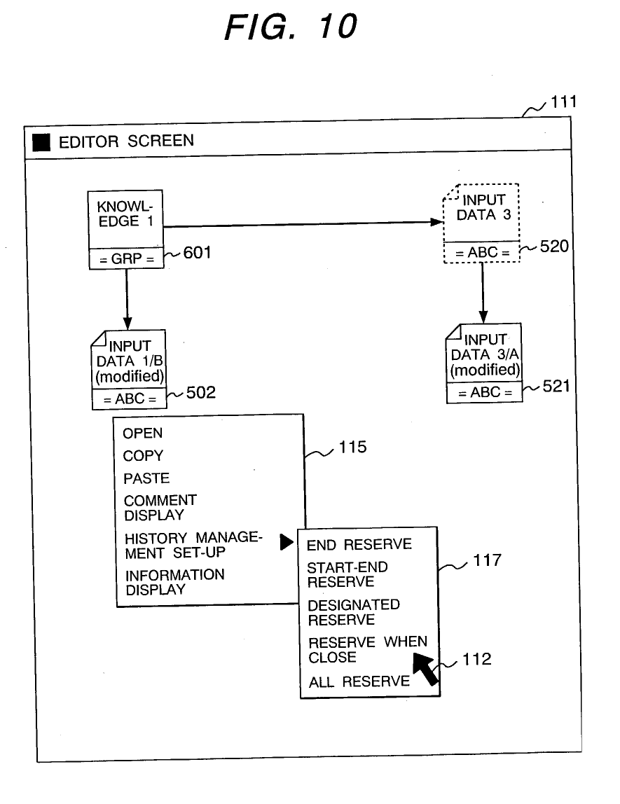

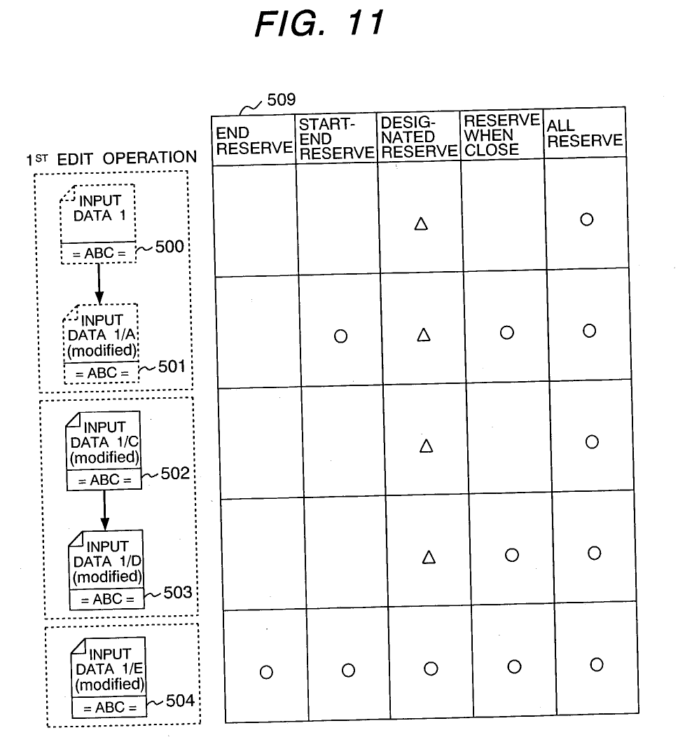

Next, explanation will be given on a method for selecting a designated menu within plural numbers of reservation menus, so as to reserve the history file, with referring to FIGS. 10 to 12. Operation is conducted for displaying a popup menu 115 after completing the operation for selecting the icon 502 when the icons 500, 502, 520 and 521 are displayed on the editor screen of the CRT, and “History Management Set-up” is selected from the popup menu 115, including “Open”, “Copy”, “Paste”, “Comment Display”, “History Management Set-up” and “Information Display”, then a sub-menu 117 for setting up the history management is displayed.

In this sub-menu 117, the following are included: “End Reserve”, “Start-End Reserve”, “Designated Reserve”, “Reserve When Close”, and “All Reserve”, and when one menu is selected from those menus, the data file can be reserved in accordance with that menu selected. Those menus can be selected in the process of changing the data file, optionally or at designation.

For example, the data file relating to the icon 500 is reserved at the end of the editing operation, thereby being the data file relating to the icon 501, in the process where the data files relating to the icons 500, 501, 502, 503 and 504 are changed through renewal thereof. In the next editing operation, a data file is produced relating to the icon 502, on a way, upon reservation through superscription, and at the end of the editing operation, it is renewed into the data file relating to the icon 503. Moreover, in the further next editing operation, it comes to be the data file relating to the icon 500. Thus, the data file is reserved as the history file corresponding to each of the icons, depending on the fact on which mode is set up in the menu, including the end reserve, the start-end reserve, the designated reserve, the reserve when closing, and all reserve, in the process where the data file relating to the each icon is changed through the renewal while the icons 500 to 504 are produced. In this case, a mark “◯” indicates that it is reserved, and a mark “Δ” to be determined on whether reserved or deleted by the designation of the user. If the user selects the end reserve, only the data file relating to the icon 504 is reserved, while other data files are deleted when the editing operation is ended. If the start-end reserve is selected in the menu, the data files are reserved, one of which is produced at first; thus, the data file corresponding to the icon 500, and the data file produced at the end; thus, the data file corresponding to the icon 504. When the designated reserve is selected in the menu, only that is reserved, which the user designates. In this case, the data file produced at the end; thus, the data file corresponding to the icon 504 is reserved, however it is determined on whether to be reserved or deleted depending on the designation by the user. If there serve when close is selected in the menu, only the data file remains, which is stored at the end in the respective editing operation, while those under the reserve condition through superscription on the way are deleted. Also, when the all reserve is selected in the menu, all of the data files stored are reserved. Further, a standard setting in the menu is the “start-end reserve” by taking into the consideration that the knowledge information of the user reflects on the every process of renewal of file.

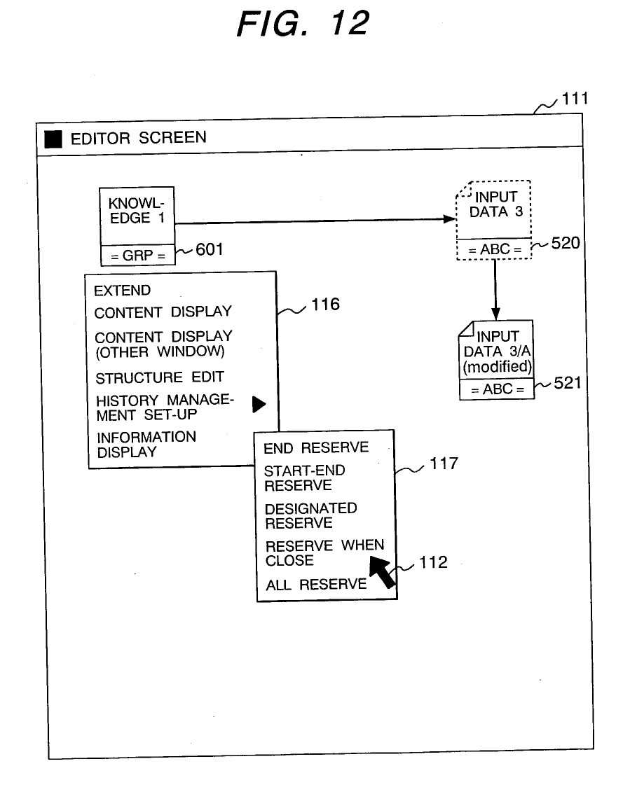

Also, the sub-menu 117 is displayed if the icon 500 is selected when the group icon 500 is displayed and the history management set-up is selected from a popup menu 116, as shown in FIG. 12. In this instance, the reservation is conducted on the data file, which is included in the group icon 500, in accordance with a menu selected, if the menu is selected arbitrarily among those included in the sub-menu, after completion of the selection. The set-up of the mode for selecting menu is effective until when the change of set-up is designated again onto the same group icon 500.

<Embodiment 3>

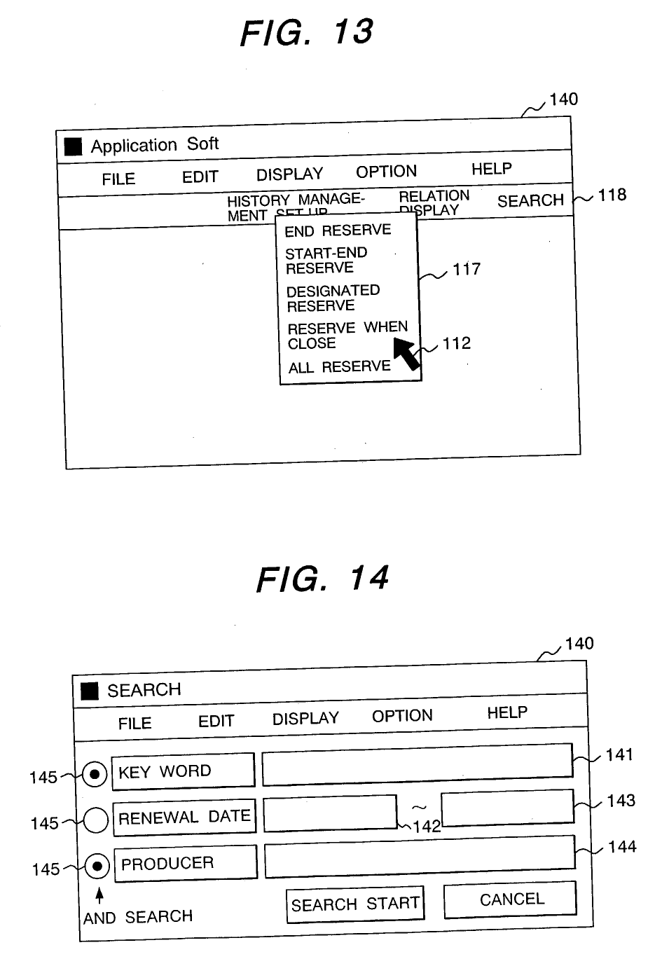

Next, explanation will be given on a history management method of the data files when using application software, by referring to FIGS. 13 and 14.

When a window 140 is displayed as a plug-in menu on the editor screen 111 with using the application software, menus relating to “History Management Set-up”, “Display Relation” and “Search” are displayed as the plug-in menu 118, in the window 140. The history management set-up comprises a function, being same to that when selecting the menu in FIG. 10, and the display of relation is a command for displaying the files, which have a connection relationship between the data files under editing, in a form of the tree chart, as shown in FIG. 2. The search is a command for conducting search on the history files by making a key word and a renewal date the search information thereof.

When the command “Search” is selected in the plug-in menu 118, various kinds of fields are displayed in the window 140, as shown in FIG. 14. A key word input field 141 is displayed, as an area where the key word is ought to be inputted. Fields 142 and 143 are displayed, as areas where the renewal date is ought to be inputted when the user tries to make search with using the renewal date, in which the field 142 is indicated as an area where a starting date of a term is to be inputted while the field 143 as an area where the last date of that term. The field 143 is displayed to be an area where the user should input a name of the producer thereof.

When information is inputted into either one of the fields relating the key word and the renewal date, a search is conducted on the history files, being coincident with at least one or both information, upon the search information. An “OR search” is conducted for finding out the history file coincident with on either one of the information, while “AND search” for finding that coincident with on both thereof. The “AND search” is started by making a “AND search” check mark ON. Also, in the key word search, only the data files of a text format are targeted among those data files, such as the entry name of the data reserved in the history information database 310, and the data files within the backup file 320, which are reserved as the comment file 330, the knowledge file 340 and the history file, for example. And, when the key word search is conducted, the search is made on the history information and the knowledge information and the management names (the file names), as the search target, upon the basis of the key word, and if the data file(s) including that keyword is/are extracted through this search, the icon(s) for data file is/are displayed on the display screen, which correspond(s) to the data file(s) extracted.

As was fully explained in the above, according to the present invention, the combined information input screen is displayed when the operation for combining is executed on at least two (2) or more of icons, thereby prompting an input of the knowledge information for giving a meaning of changing process thereof on the group of data files, which are designated to be a target of combination, and reserving the knowledge information inputted as the data file when it is inputted, while reserving the management names indicative of addresses of reservation of the respective data of the group, which are designated to be the target of combination, as well as, the management name after the combination indicative of an address of the knowledge information, as the search information, therefore it is possible to relate the knowledge information and the data files to each other independent upon the application software.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A method for managing data file history, comprising the following steps of:
reserving a data file produced accompanying an input of data upon basis of edition operation, with comment information, to be history information, relating to a management name thereof;
displaying plural numbers of data files on a display screen, through an icon for data file unique to each of the data files, responding to the editing operation of the data files, and also displaying a relationship of the each of the icons through an icon for showing history;
displaying a combined information input screen on said display screen when a combining operation is executed on at least two or more of the plural numbers of icons for data files displayed on said display screen;
reserving knowledge information as the data file, when said knowledge information is inputted for giving meaning onto changing processes of a group of the data files, which are designated to be a target for said combination, accompanying the display of said combined information input screen; and
reserving a management name indicative of an address of reservation of the each data of the group of data files, which are designated to be said target of combination, and a management name indicative of an address of reservation of said knowledge information, to be information for searching an icon name after combining.

2. A method for managing data file history, as described in the claim 1, wherein the respective comment information of the group of data files, which are designated to be said target of combining, is displayed in a designated area on said combined information input screen, together with the management name of the each data file designated to be said target of combining, when displaying the combined information input screen on said display screen.

3. A method for managing data file history, as described in the claim 1, further comprising the following steps of: displaying a group of data files designated to be a target of said combination on said display screen by an icon for a combined data file, being unique to said group of data files, when the editing operation is executed on the data files including the group of data files, which are designated to be said target of combination, responding to that editing operation; displaying other uncombined data files, which are designated in said editing operation, on said display screen by the icon for data file, being unique to said other uncombined data files; and displaying a mutual relationship of said each icon on said display screen by an icon for history.

4. A method for managing data file history, as described in the claim 3, wherein if an extension operation is executed on the icon for the combined data file, when the icon for combined data file of the group of data files, which are designated to be said target of combination, is displayed on said display screen, the group of data files before combination are searched, belonging to said icon for the combined data file by using the management name as the search information, and a group of data files obtained in this search and other data files relating before the combination are displayed on the display screen by icons for data file, each being unique to said data file, while displaying the mutual relationship of said each icon on said display screen by the icon for history and restoring the icon before the combination on said display screen.

5. A method for managing data file history, as described in the claim 1, wherein if a display operation is executed on the icon for the combined data file, when the icon for combined data file of the group of data files, which are designated to be said target of combination, is displayed on said display screen, search is made on said knowledge information while searching on the group of data file before the combination, belonging to said icon for combined data file, by using the file name after combination as the search information, and a combined information input screen is displayed on said display screen, while displaying the management name, comment information and the knowledge information of each the group of data files before said combination, in an area designated in said combined information input screen respectively.

6. A method for managing data file history, as described in the claim 1, wherein a base management name indicative of the management name of a producer of said history information is reserved when said data and comment information are reserved as the history information by relating to the management name, and when icons for data files are displayed in plural numbers thereof on said display screen, while deleting the icon for data file designated in said deletion operation, an icon for history is displayed, being indicative of a mutual relationship between icons for data files having a relation to said icon for data file, which is deleted, among remaining icons for data files, while reserving comment information of the data file for deletion corresponding to the icon for data file, which is designated in said deleting operation, into a data file at an address of reservation, which has a management name of said data file for deletion as a base management name thereof, and changing the base management name of said data file at an address of reservation into the base management name reserved in said data file for deletion and reserving, and thereafter said data file for deletion is deleted, if deletion operation is executed on any one of said icons for data files.

7. A method for managing data file history, as described in the claim 1, wherein in advance to reservation of each of said data files, a reserve condition is set up for the data file to be reserved in a process where said each data file is produced, and only the data file is reserved, being in conformity with said reserve condition set up, when said each data file is produced.

8. A method for managing data file history, as described in the claim 7, wherein a plug-in menu for designating the reserve condition of said data file is displayed on an application display screen.

9. A method for managing data file history, as described in the claim 1, wherein a search is executed on said history information and the knowledge information and the file name as a search target, upon basis of said key word, when a key word search operation is executed accompanying an input of a key word, and a data file is displayed on the display screen by means of an icon for data file, if it is extracted to include said key word therein in that search.

10. An apparatus for managing data file history, comprising:
a history information reserving means for reserving a data file produced accompanying an input of data upon basis of edition operation, with comment information, to be history information, relating to a management name thereof;
an icon displaying means for displaying plural numbers of data files on a display screen, through an icon for data file unique to each of the data files, responding to the editing operation of the data files, and also displaying a relationship of the each of the icons through an icon for showing history;
a combined information input screen displaying means for displaying a combined information input screen on said display screen when a combining operation is executed on at least two or more of the plural numbers of icons for data files displayed on said display screen;
a knowledge information reserving means for reserving knowledge information as the data file, when said knowledge information is inputted forgiving meaning onto changing processes of a group of the data files, which are designated to be a target for said combination, accompanying the display of said combined information input screen; and
a combined file reserving means for reserving a management name indicative of an address of reservation of the each data of the group of data files, which are designated to be said target of combination, and a management name indicative of an address of reservation of said knowledge information, to be information for searching an icon name after combining.

11. An apparatus for managing data file history, as described in the claim 10, wherein said history information reserving means reserves a base management name indicative of an management name of a producer of said history information, when reserving said comment information to be the history information with relating to the management name.
